(19) United States
(12) Patent Application Publication
(10) Pub. No.: US 2011/0261228 A1
(43) Pub. Date: Oct. 27, 2011

(54) IMAGE CAPTURE MODULE AND IMAGE CAPTURE METHOD FOR AVOIDING SHUTTER LAG

(76) Inventors: Ming-Hui Peng, Jhubei City (TW); Han-Min Cheng, Jhubei City (TW)

(21) Appl. No.: 13/092,776

(22) Filed: Apr. 22, 2011

(30) Foreign Application Priority Data
Apr. 23, 2010 (TW) 099112842

(51) Int. Cl. H04N 5/76

(52) U.S. Cl. 348/231.6; 348/E05.062

(57) ABSTRACT

An image capture module and an image capture method are provided. The image capture module includes an image signal processor, a preview interface module, and an image temporary storage module. The image signal processor receives an image data stream and processes the stream to generate a preview image stream and an output image stream, which will be respectively sent to the preview interface module and the image temporary storage module. The preview image stream has a first preview image frame while the output image stream has a first output image frame corresponding to the first preview image frame. When an image capture command is generated after the preview interface module receives and outputs the first preview image frame, the image temporary storage module will output the first output image frame from the buffer memory unit.

### BACKGROUND OF THE INVENTION

1. Field of the Invention

The present invention generally relates to an image capture module and an image capture method thereof. Particularly, the present invention relates to an image capture module and an image capture method that avoids shutter lag.

2. Description of the Prior Art

In recent years, noticeable development in the range and field of the application of digital imaging can be seen while technological levels are also continuously on the raise. In order to satisfy the demand requirements of users for digital imaging, digital image capturing capabilities are usually incorporated into digital cameras and other such related electronic devices in order to provide conveniences to the users in photographing various different occasions on various different timings.

FIG. 1A illustrates a schematic diagram of a conventional digital image capture module. The conventional digital image capture module includes an image sensor 20, an image processor 10, a preview interface device 30, and a preview display 60. In a preview mode before taking pictures, the image sensor 20 converts received light into a signal 21 and transmits the signal 21 to the image processor 10. After processing the signal 21 into an image signal 11, the image processor 10 then transmits the image signal 11 to the preview interface device 30 and the preview display 60 that is connected to the back-end of the preview interface device 30 in order to generate a preview image. When a user sees a target image through the preview display 60 in the preview mode, the user can press the shutter to enter an image capture mode and capture the target image from the image processor 10.

As shown in FIG. 1B, the image signal 11 includes a first image frame 61, a second image frame 63, and a third image frame 65 in chronological order. The first image frame 61, the second image frame 63, and the third image frame 65 are images respectively captured during a continuous time by the image sensor 20. After the first image frame 61 is completely transmitted from the preview interface device 30 to the preview display 60, the preview display 60 will display the first image frame 61 as the preview image. In the present instance, the image signal outputted from the image processor 10 is the second image frame 63. In other words, when the user sees the preview of the first image frame 61 and presses the shutter, the image which can be captured from the image processor 10 is not necessarily the first image frame 61 that has been completely outputted. Since the preview image and captured image are different, the so-called “shutter lag” occurs as a result.

In addition, in order to increase the frame rate in the preview mode, the image sensor 20 usually outputs the image signal in the preview mode with lower resolution and higher frame rates while the image signal is processed by the image processor 10 into the first image frame 61 and the second image frame 63. After the user presses the shutter, the image sensor 20 is switched to output the image signal in full resolution but with lower frame rates (for example, the third image frame 65). However, time is also wasted during this process of switching outputted frames in the image sensor 20 and as a result a window of time forms in the signal between the second image frame 63 and the third image frame 65. This window of time amplifies the effects of the mentioned “shutter lag”, making the image and time difference between the preview image and the captured output image even more obvious to the user.

### SUMMARY OF THE INVENTION

It is an object of the present invention to provide an image capture module and an image capture method thereof to solve the shutter lag problem.

It is another object of the present invention to provide an image capture module and an image capture method thereof to make the captured output image the same as the preview image when the user presses the shutter.

It is yet another object of the present invention to provide an image capture module and an image capture method thereof that may be easily integrated on a back-end system and on other application devices.

The image capture module includes an image signal processor, a preview interface module, and an image temporary storage module. The image capture module connects to an image source and receives an image data stream provided by the image source. The image source receives and converts external light into an electronic signal to generate the image data stream. The image signal processor receives the image data stream from the image source. The image signal processor processes the received image data stream to generate a preview image stream and an output image stream. The preview image stream is transmitted to the preview interface module and then outputted to form a preview image. The output image stream is transmitted to the image temporary storage module to be temporarily stored. In other words, the preview image stream and the output image stream form two independent signal paths.

The preview image stream includes a first preview image frame; the output image stream includes a first output image frame corresponding to the first preview image frame. In the preview mode, when the first preview image frame is received and outputted by the preview interface module, the first output image frame is also synchronously received and temporarily stored by the image temporary storage module. After the preview interface module completely outputs the first preview image frame, the first preview image frame will then be display as the preview image for the user. At this time, the first output image frame is also completely received and temporarily stored by the image temporary storage module.

When the user presses the shutter or starts other triggering devices to generate an image capture command, the system will output the temporarily stored first output image frame as the captured output image in accordance to the image capture command. Due to the fact that the first preview image frame corresponds to the first output image frame, the images shown by the first preview image frame and the first output image frame are identical. In this design manner, the shutter lag or image processing lag can be avoided, and the difference between the image that was seen by the user when pressing the shutter and the captured output image can also be reduced.

The advantage and spirit of the invention may be understood by the following detailed descriptions together with the appended drawings.

### BRIEF DESCRIPTION OF THE APPENDED DRAWINGS

FIG. 1A illustrates a schematic diagram of a conventional image capture module.

FIG. 1B illustrates a schematic diagram of the conventional image capture module generating an image signal.

FIG. 2 illustrates a schematic diagram of an embodiment of the image capture module.

FIG. 3 illustrates a functional block diagram of an embodiment of an image signal in the image capture module.

FIG. 4 illustrates schematic diagrams of another embodiment of the image capture module.

FIG. 5 illustrates schematic diagrams of an embodiment including a delay time T.

FIG. 6 illustrates schematic diagrams of an embodiment including an identification number.

FIG. 7 illustrates schematic diagrams of an embodiment of a buffer memory unit.

FIG. 8A illustrates schematic diagrams of an embodiment including an image capture preparing mode.

FIG. 8B illustrates schematic diagrams of another embodiment including the image capture preparing mode.

FIG. 9 illustrates a flowchart of an embodiment of the image capture method.

FIG. 10 illustrates a flowchart of another embodiment of the image capture method.

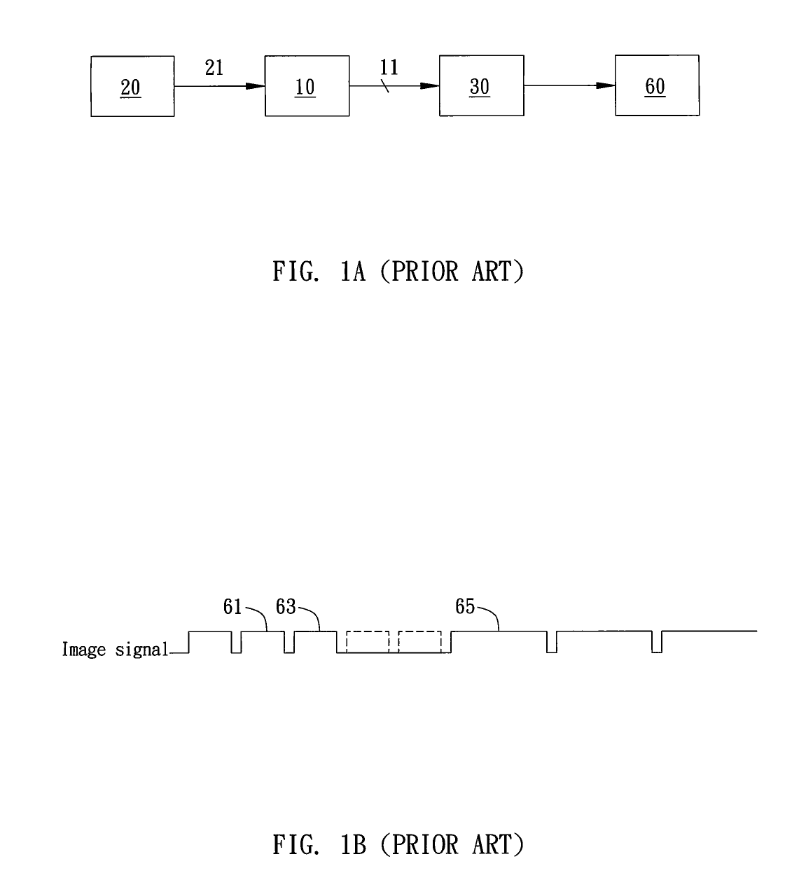

### DETAILED DESCRIPTION OF THE INVENTION

The present invention provides an image capture module and an image capture method thereof. In a preferred embodiment, the image capture module and the image capture method of the invention are applicable in a digital camera. However, in other embodiments, the image capture module and the image capture method of the present invention may also be applied to other electronic apparatuses with image process capabilities, such as mobile phones, personal digital assistants (PDAs), global positioning satellite navigation (GPS Navigation) devices, or handheld video game devices.

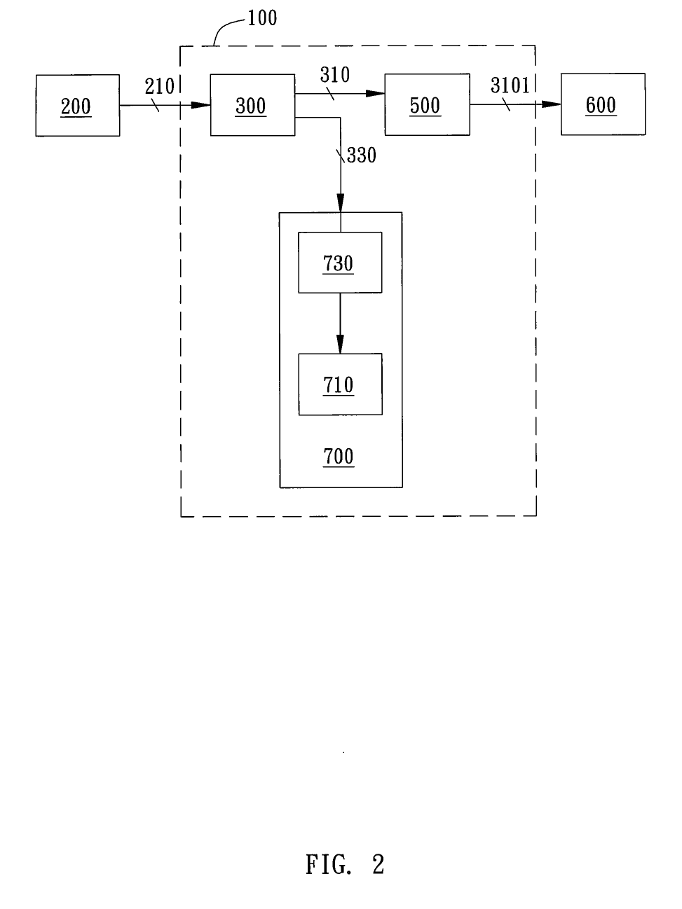

As shown in FIG. 2, the image capture module 100 mainly includes an image signal processor 300, a preview interface module 500, and an image temporary storage module 700. The image capture module 100 is connected to an image source 200 and receives an image data stream 210 provided by the image source 200. The image source 200 preferably includes various image sensors, such as Charge-Coupled Device (CCD), Complementary Metal-Oxide-Semiconductor (CMOS), and so on.

The image source 200 receives light from outside and converts the light into an electronic signal to generate an image data stream 210. The image signal processor 300 receives the image data stream 210 from the image source 200. In the preferred embodiment, the image data stream 210 generated by the image source 200 is outputted with a fixed resolution at a fixed timing. However, in other embodiments, the timing/frame frequency or resolution of the image source 200 generating the image data stream 210 may be adjusted to achieve additional effects.

As shown in FIG. 2, the image signal processor 300 processes the received image data stream 210 to generate a preview image stream 310 and an output image stream 330. The image signal processor 300 preferably performs the process of lowering the resolution or adjusting the data format on the image data stream 210 to form the preview image stream 310, wherein the data format of the preview image stream 310 may be RGB or YUV format for the following preview or output process. In addition, the image signal processor 300 may also perform noise filtering or any other processes on the image data stream 210 to form the preview image stream 310.

The preview image stream 310 is transmitted to the preview interface module 500. Within specific product designs, the preview interface module 500 can be connected to a baseband processor of the system on demand, and then connected to an application apparatus such as a display. However, in other embodiments, the preview interface module 500 can be designed to directly connect to the application apparatus such as the display to provide a preview image. As shown in FIG. 2, the preview interface module 500 receives the preview image stream 310 and then outputs the preview image stream 310 to the baseband processor of the system/the display 600. After the baseband processor of the system/the display 600 fully receives a certain frame of the preview image stream 310, the baseband processor of the system/the display 600 will display the image of the frame as the preview image for the user to watch.

As shown in FIG. 2, the image signal processor 300 preferably performs the data format adjusting process or noise filtering process on the image data stream 210 to form the output image stream 330, wherein the data format of the output image stream 330 may be RGB, YUV, or RAW format for the following compression or output process. In the preferred embodiment, the image signal processor 300 will not lower the resolution of the image data stream 210 to form the output image stream 330. However, in other embodiments, the resolution of the image data stream 210 may be lowered to form the output image stream 330 to meet different system output requirements.

The generated output image stream 330 is transmitted to the image temporary storage module 700. In other words, the preview image stream 310 and the output image stream 330 form two independent signal paths and the preview image stream 310 and the output image stream 330 are transmitted to different modules to be processed. The image temporary storage module 700 has at least one buffer memory unit 710, and the output image stream 330 is temporarily stored in the buffer memory unit 710. In a preferred embodiment as shown in FIG. 2, the image temporary storage module 700 includes an image compression unit 730 disposed in front of the buffer memory unit 710. The output image stream 330 is compressed by the image compression unit 730 and then temporarily stored in the buffer memory unit 710. In a preferred embodiment, the image compression unit 730 is a JPEG image compression engine used for compressing the frames of the output image stream 330 to be JPEG images. However, in other embodiments, the image compression unit 730 can be different kinds of image compression engine.

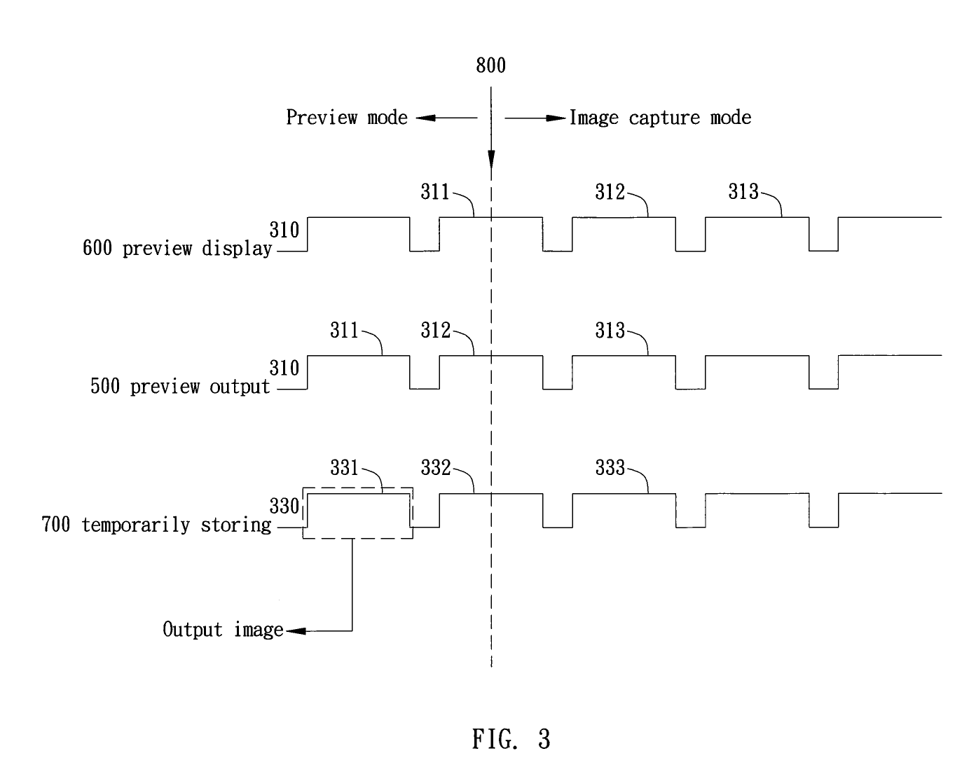

As shown in FIG. 3, the preview image stream 310 includes a first preview image frame 311, a second preview image frame 312, and a third preview image frame 313. The output image stream 330 includes a first output image frame 331, a second output image frame 332, and a third output image frame 333, wherein the first preview image frame 311, the second preview image frame 312, and the third preview image frame 313 respectively correspond to the first output image frame 331, the second output image frame 332, and the third output image frame 333. In other words, the first preview image frame 311 and the first output image frame 331 are generated from the same frame of the original image data stream 210 provided by the image source 200. Subsequent preview image frames and output image frames are similarly generated in the same manner. However, in a preferred embodiment, the resolution of the preview image frame is usually adjusted to meet the pixel size of the display. Therefore, the resolution of the first preview image frame 311 is preferably lower than the resolution of the first output image frame 331.

As shown in a preferred embodiment of FIG. 3, in a preview mode, when the first preview image frame 311 is received and outputted by the preview interface module 500, the first output image frame 331 is also received and temporarily stored by the image temporary storage module 700 at the same time. After the preview interface module 500 completely outputs the first preview image frame 311 to the baseband processor of the system/the display 600, the first preview image frame 311 will be displayed as the preview image for the user to view. In other words, when the user sees the first preview image frame 311 and presses the shutter or starts other triggering devices to enter into an image capture mode, the first preview image frame 311 is fully outputted by the preview interface module 500, and the first output image frame 331 is also fully received and temporarily stored by the image temporary storage module 700.

Since an image capture command 800 will be generated to enter into the image capture mode when the user presses the shutter or starts other triggering devices, at this time, the system will output the temporarily stored first output image frame 331 as the captured output image according to the image capture command 800. In addition, the first output image frame 331 can be transmitted to the preview interface module 500 to be outputted for the user to confirm or check the captured output image. The first preview image frame 311 corresponds to the first output image frame 331; that is to say, the first preview image frame 311 and the first output image frame 331 are both generated from the same frame of the image data stream 210. Therefore, the images the first preview image frame 311 and the first output image frame 331 shown will be the same. With this design, the shutter lag or image processing lag can be avoided, and the difference between the image saw by the user when pressing the shutter and the captured output image can be also reduced.

In addition, in the preferred embodiment, after the image capture command 800 is generated to enter into the image capture mode, the preview interface module 500 and the image temporary storage module 700 can stop receiving the preview image stream 310 and the output image stream 330 respectively to reduce the power consumption. However, when leaving the image capture mode and entering into the preview mode again, the preview interface module 500 and the image temporary storage module 700 will start to receive the preview image stream 310 and the output image stream 330 respectively.

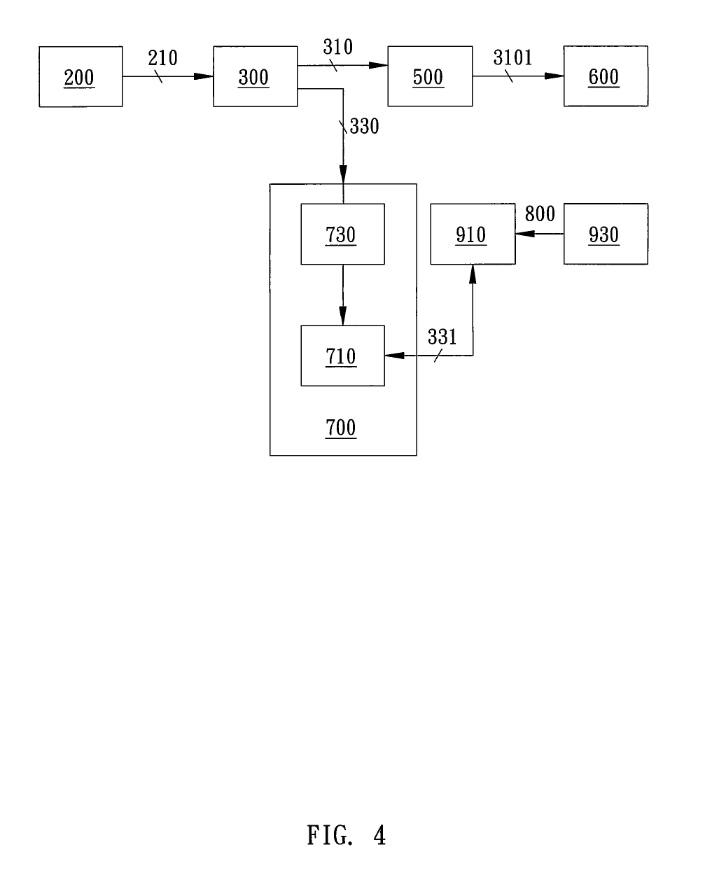

In the embodiment shown in FIG. 4, the image capture module 100 further includes a central processing unit 910 and a shutter 930. The shutter 930 generates the image capture command 800 according to the operation of the user, and transmits the image capture command 800 to the central processing unit 910. In other embodiments, the shutter 930 can be formed by a touch panel or other triggering devices. When the central processing unit 910 receives the image capture command 800, the central processing unit 910 will access and output the corresponding first output image frame 331 from the buffer memory unit 710 according to the time that the image capture command 800 is generated.

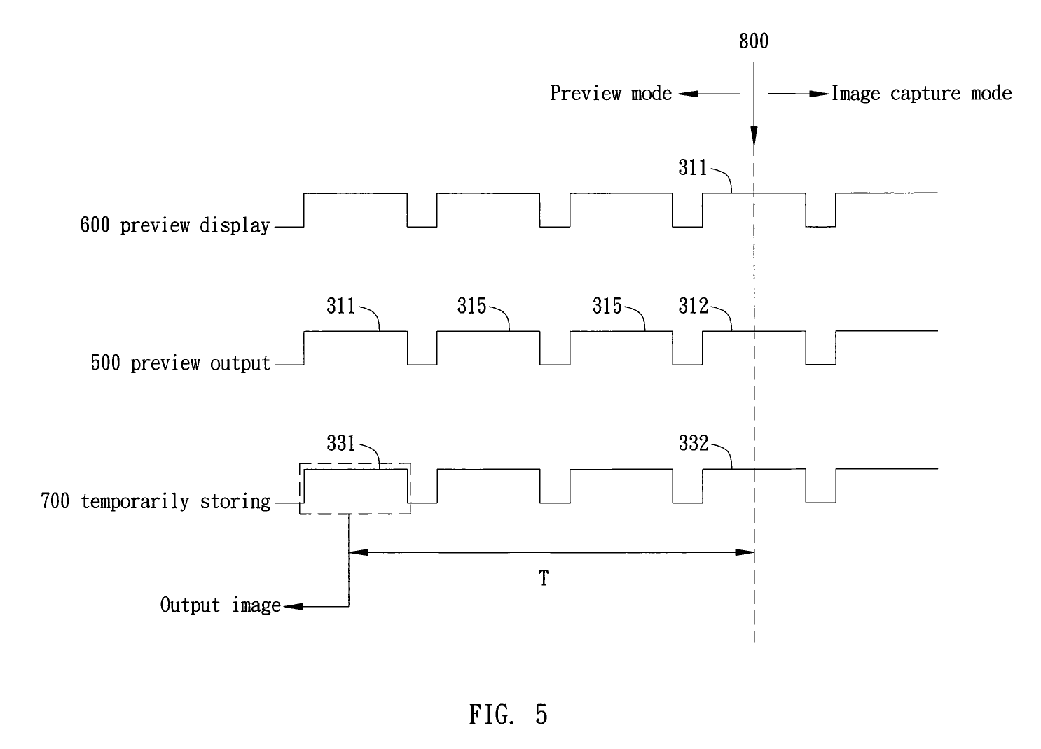

In the embodiment shown in FIG. 5, a time point that the system receives the image capture command 800 occurs during the receiving and outputting of the second preview image frame 312 by the preview interface module 500. At this instance, the preview image shown on the display 600 is the first preview image frame 311. However, due to the fact that lag is caused by the baseband processor/the display 600 or other data processes, the second preview image frame 312 is not the frame next to the first preview image frame 311. There will be one or several other preview image frames 315 existing between the first preview image frame 311 and the second preview image frame 312. In order to correctly output images corresponding to the first preview image frame 311 the user is previewing, the central processing unit 910 is designed to determine whether or not to access the output image by accessing the output image in accordance to a default preview delay time T. In this manner, the correct output image may be accessed. For example, when the image capture command 800 is generated during the process of the preview interface module 500 receiving and outputting the second preview image frame 312, the central processing unit 910 will access the first output image frame 331 before the default preview delay time T from the buffer memory unit 710 as the output image. The default preview delay time T can be known by tests in advance, so that it can be preset in the central processing unit 910.

However, in other embodiments, it is possible that no other preview image frames existed between the first preview image frame 311 and the second preview image frame 312, that is to say, no lag is caused by the baseband processor/the display 600 or other data process. At this time, if the image capture command 800 is generated during the process of the preview interface module 500 receiving and outputting the second preview image frame 312, namely the first preview image frame 311 is the last frame outputted by the preview interface module 500, the central processing unit 910 can also directly access the first output image frame 331 previous to the second output image frame 332 from the buffer memory unit 710 as the output image. Wherein, the second output image frame 332 corresponds to the second preview image frame 312, and when the second preview image frame 312 is received and outputted by the preview interface module 500, the second output image frame 332 is preferably during the process of being compressed by the image compression unit 730 and temporarily stored in the buffer memory unit 710.

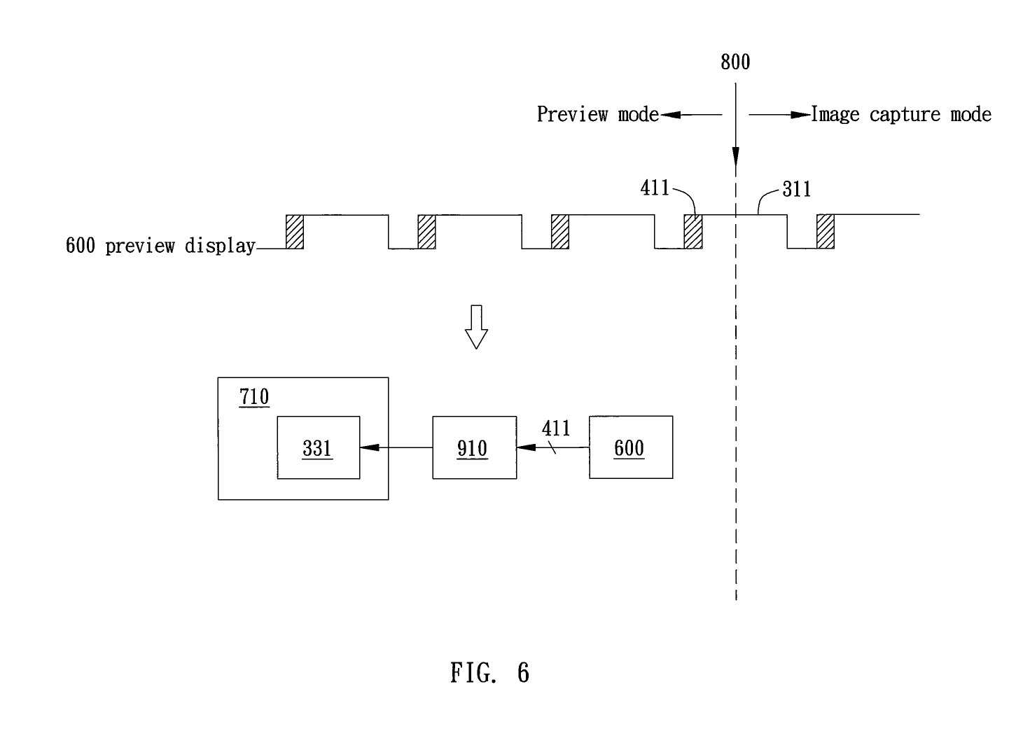

In the embodiment shown in FIG. 6, each preview image frame has an identification number. For example, the first preview image frame 311 has the first identification number 411. Preferably, the identification number is included in the data packet forming the preview image frames and it can be interpreted by the baseband processor/the display 600. When the first preview image frame 311 is displayed by the baseband processor/the display 600 as the preview image and the user triggers the shutter 930 to generate the image capture command 800, the baseband processor/the display 600 will transmit the first identification number 411 of the first preview image frame 311 back to the central processing unit 910. The central processing unit 910 will access the corresponding first output image frame 331 from the buffer memory unit 710 as the output image according to the received first identification number 411.

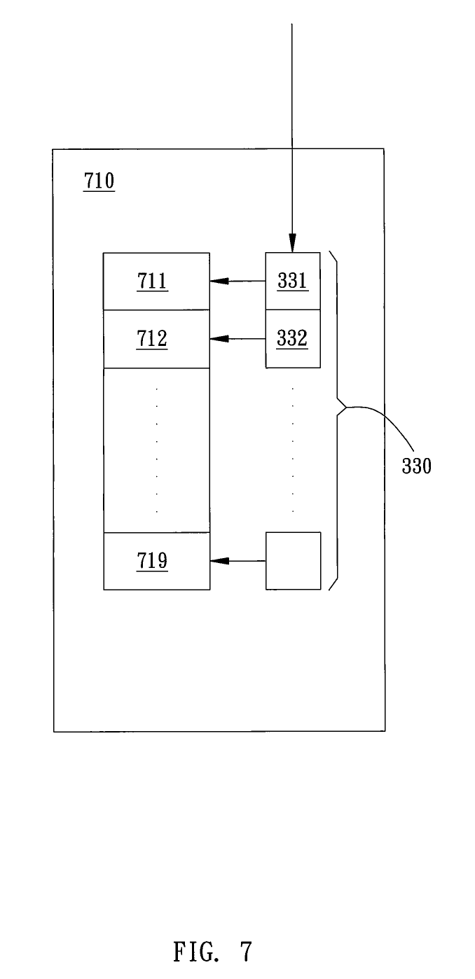

As mentioned above, the preview image frame displayed as the preview image is not necessarily closely connected to the preview image frame received by the preview interface module 500 as other preview image frames may existed in between them. Therefore, in the embodiment shown in FIG. 7, the buffer memory unit 710 can include a plurality of buffers 711, 712, . . . , 719 to temporarily store the output image frames corresponding to the preview image frames. As shown in FIG. 7, the first output image frame 331 and the second output image frame 332 in the output image stream 330 are stored into the buffers 711 and 712 in order. After the last buffer 719 is occupied by an output image frame, the following output image frames will be stored into the buffers 711 and 712 in order to overwrite the first output image frame 331 and the second output image frame 332 originally stored in the buffers 711 and 712.

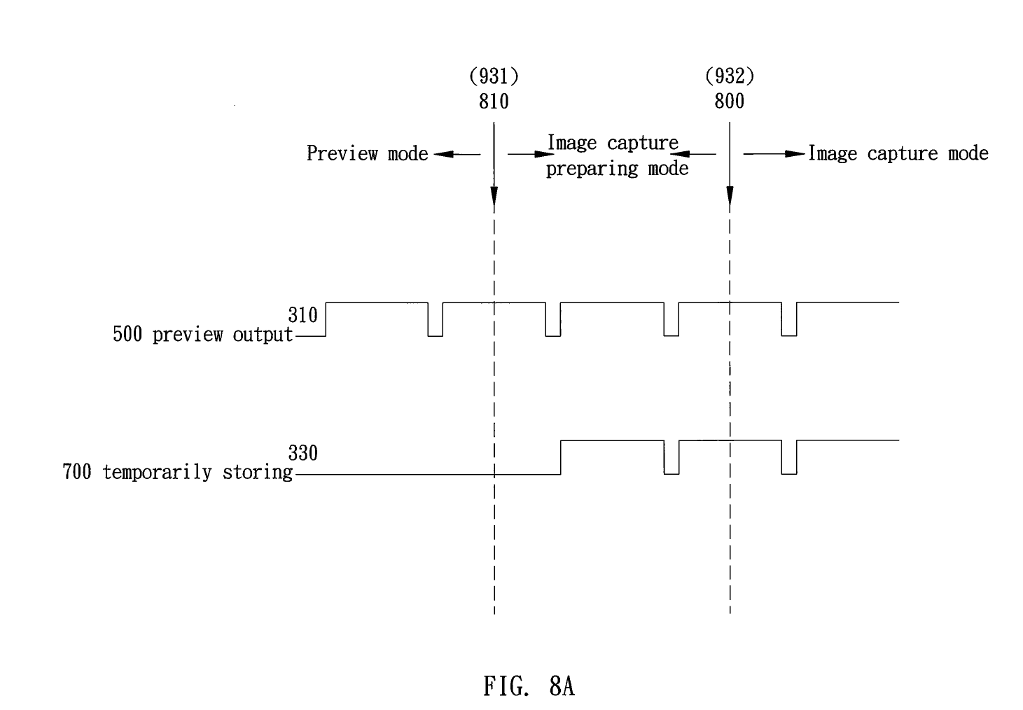

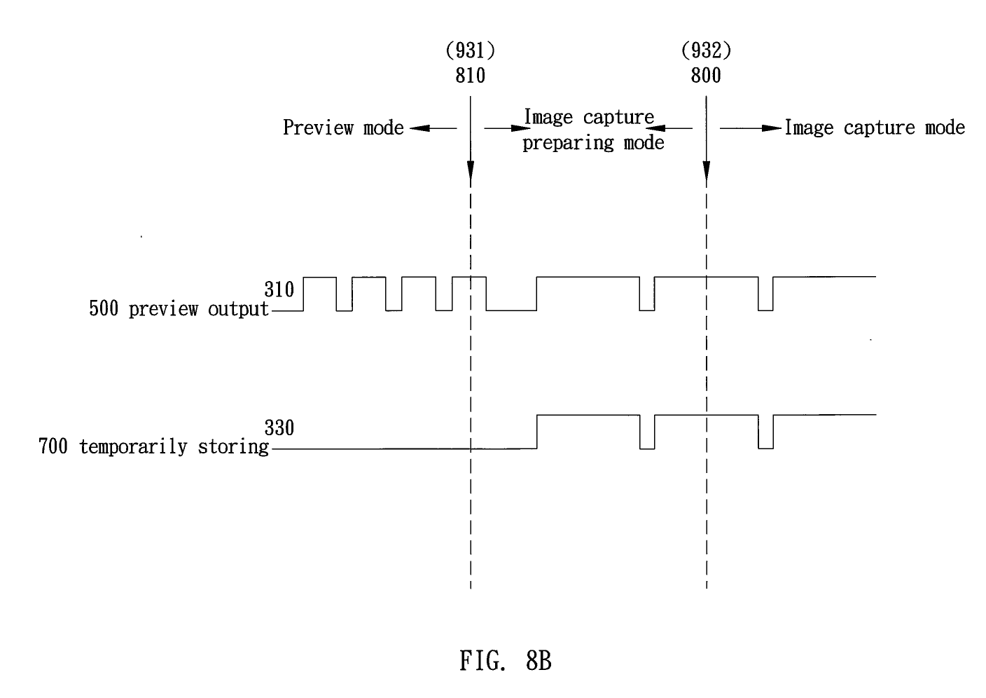

As shown in the embodiment of FIG. 8A, there is an image capture preparing mode between the preview mode and the image capture mode, and the image capture preparing mode is triggered by an image capture preparing command 810. In a preferred embodiment, the shutter 930 has a first trigger 931 and a second trigger 932. Preferably, the first trigger 931 can be triggering actions such as lens focusing or metering. This triggering action can be achieved by touching the first trigger 931 or the focus position on the touch panel. Preferably, the second trigger 932 is the triggering action of capturing image, for example, pressing the shutter button or touching the shutter icon on the touch panel.

As shown in FIG. 8A, in the preview mode, the first trigger 931 is not activated, at this time, only the preview image stream 310 is generated by the image signal processor 300 and then transmitted to the preview interface module 500; the output image stream 330 is not generated and transmitted to the image temporary storage module 700. When the image capture preparing command 810 is generated, namely the first trigger 931 is activated, the image signal processor 300 will start to generate and transmit the output image stream 330 to the image temporary storage module 700. The following processes after entering the image capture mode is the same as mentioned above. With this design, the power consumption of the system in the preview mode can be further reduced to enhance the efficiency of the system.

In addition, in other embodiments, as shown in FIG. 8B, in the preview mode before receiving the image capture preparing command 810, the system can switch the image source 200 to provide a lower-resolution image data stream 210 to make the preview image stream 310 have higher image renew frequency. After receiving the image capture preparing command 810 and entering into the following image capture preparing mode, the system will switch the image source 200 to provide a higher-resolution image data stream 210, and to generate the preview image stream 310 and the output image stream 330 at the same time according to the higher-resolution image data stream 210.

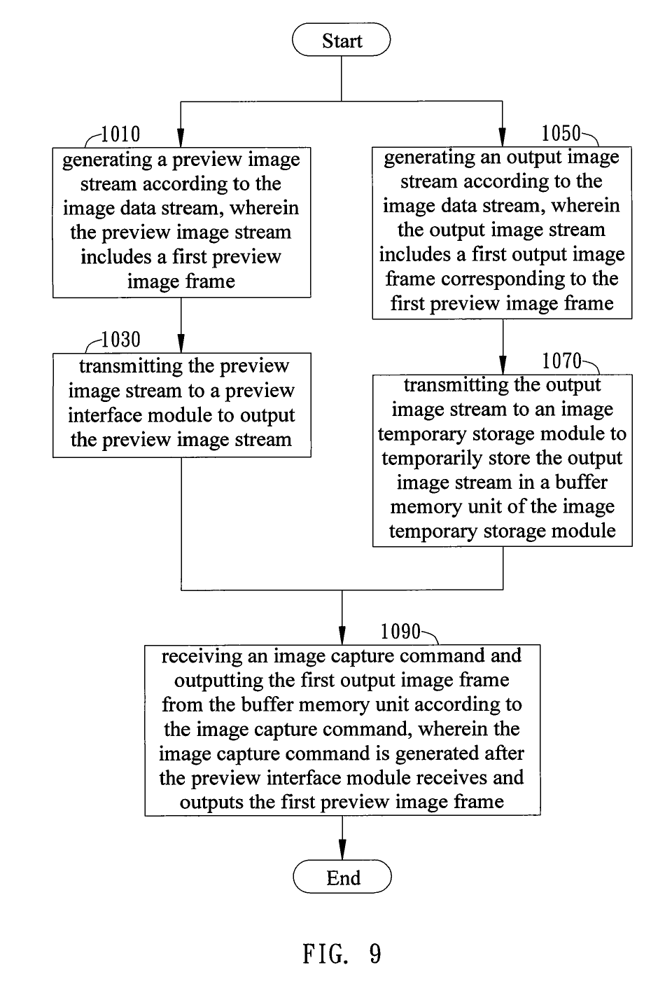

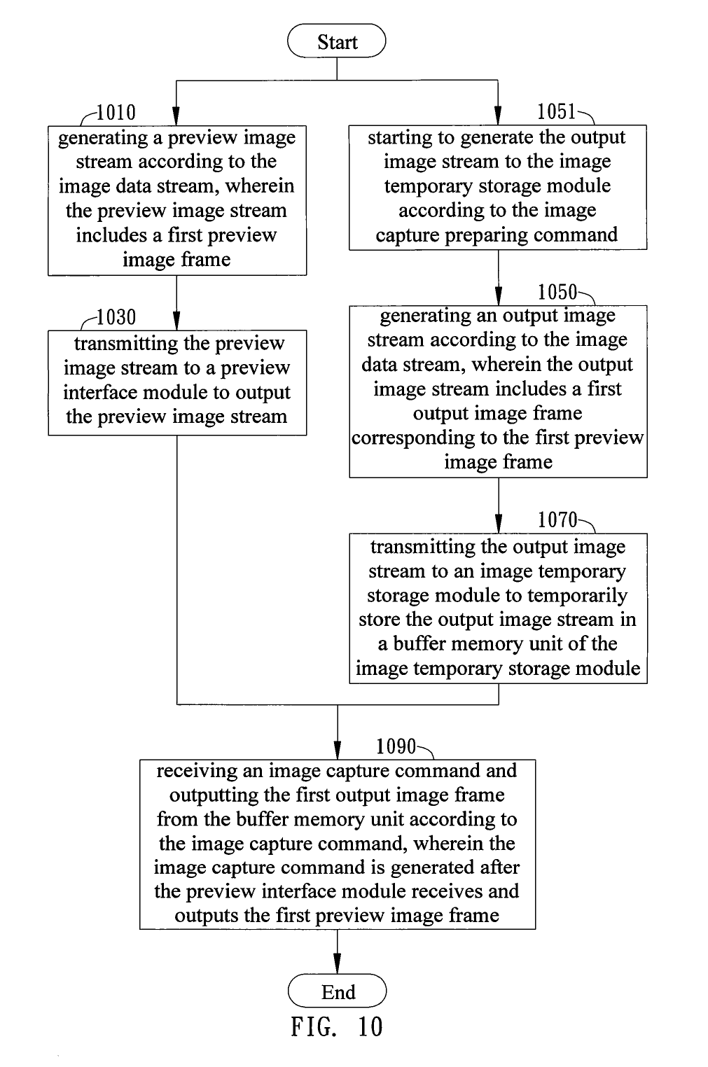

FIG. 9 illustrates a flowchart of an embodiment of the image capture method. As shown in FIG. 9, the step 1010 includes generating a preview image stream according to the image data stream, wherein the preview image stream includes a first preview image frame. Preferably, the preview image stream is formed by performing resolution lowering, data format adjusting, noise filtering or other process on the image data stream, and the data format of the preview image stream can be RGB or YUV format for the following preview or output process.

The step 1030 includes transmitting the preview image stream to a preview interface module to output the preview image stream. After the preview interface module receives the preview image stream, the preview interface module will output the preview image stream to the application apparatus such as the baseband processor of the system/the display. After the baseband processor of the system/the display fully receives a certain frame of the preview image stream, the baseband processor of the system/the display will display the image of the frame as the preview image for the user to watch.

The step 1050 includes generating an output image stream according to the image data stream, wherein the output image stream includes a first output image frame corresponding to the first preview image frame. In other words, the first output image frame and the first preview image frame are generated from the same frame of the original image data stream. Preferably, the output image stream is formed by performing data format adjusting, noise filtering or other process on the image data stream. The data format of the output image stream can be RGB, YUV, or RAW format for the following compression or output process. In a preferred embodiment, the resolution lowering process will not performed on the image data stream to form the output image stream. However, in other embodiments, the output image stream can be also formed in a resolution lowering way to meet different system output requirements.

The step 1070 includes transmitting the output image stream to an image temporary storage module to temporarily store the output image stream in a buffer memory unit of the image temporary storage module. In other words, the preview image stream and the output image stream form two independent signal paths and the preview image stream and the output image stream are transmitted to different modules to be processed. In a preferred embodiment, when the first preview image frame is received and outputted by the preview interface module, the first output image frame is also received and temporarily stored by the image temporary storage module synchronously. In addition, in order to reduce the loading of the buffer memory unit or meet the requirement of the output image format, the output image stream can be compressed by the image compression unit and then temporarily stored into the buffer memory unit. The above-mentioned compression format can be JPEG format, but not limited to this.

The step 1090 includes receiving an image capture command and outputting the first output image frame from the buffer memory unit according to the image capture command, wherein the image capture command is generated after the preview interface module receives and outputs the first preview image frame. As mentioned above, after the preview interface module fully outputs the first preview image frame, the first preview image frame will be displayed as the preview image for the user to watch. In other words, when the user sees the first preview image frame and presses the shutter or starts other triggering devices to generate the image capture command, the first output image frame is also be fully received and temporarily stored by the image temporary storage module. At this time, the system will output the temporarily stored first output image frame as the captured output image according to the image capture command. Since the first preview image frame corresponds to the first output image frame, and the first preview image frame and the first output image frame are both generated from the same frame of the image data stream, the images the first preview image frame and the first output image frame show will be the same. With this design, the shutter lag or image processing lag can be avoided, and the difference between the image saw by the user when pressing the shutter and the captured output image can be also reduced.

In the embodiment shown in FIG. 10, the output image stream generating step 1050 includes a step 1051 of starting to generate the output image stream to the image temporary storage module according to the image capture preparing command. Preferably, the image capture preparing command is triggered by the first trigger of the shutter or other triggering devices at the same time, and the above-mentioned triggering action is used for controlling the lens focusing or metering. Because the system has not to generate the output image stream before receiving the image capture preparing command, and only needs to generate the preview image stream, this embodiment can further reduce the power consumption of the system in the preview mode to enhance the efficiency of the system.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. An image capture module for capturing images from an image data stream provided by an image source, comprising:
an image signal processor, for receiving the image data stream and generating a preview image stream and an output image stream respectively according to the image data stream, wherein the preview image stream comprises a first preview image frame, and the output image stream comprises a first output image frame corresponding to the first preview image frame;
a preview interface module, for receiving and outputting the preview image stream from the image signal processor; and
an image temporary storage module, comprising at least one buffer memory unit, the image temporary storage module receiving the output image stream from the image signal processor and temporarily storing the output image stream in the buffer memory unit;
wherein the image temporary storage module outputs the first output image frame from the buffer memory unit when an image capture command is generated after the preview interface module receives and outputs the first preview image frame.

2. The image capture module of claim 1, further comprising a central processing unit signally connected to the image temporary storage module, the central processing unit receiving the image capture command and accessing the first output image frame from the buffer memory unit in accordance to the image capture command.

3. The image capture module of claim 2, wherein the preview image stream comprises a second preview image frame following the first preview image frame, a time point of the central processing unit receiving the image capture command occurring during the receiving and outputting of the second preview image frame by the preview interface module, the central processing unit determining in accordance to the time point and a default preview delay time of accessing the first output image frame.

4. The image capture module of claim 2, wherein the first preview image frame has an identification number, the central processing unit determines accessing according to the identification number the first output image frame from the buffer memory unit.

5. The image capture module of claim 1, wherein a timing of the preview interface module receiving and outputting the first preview image frame and a timing of the image temporary storage module receiving and temporarily storing the first output image frame are simultaneously occurring.

6. The image capture module of claim 1, wherein a resolution of the first preview image frame is lower than a resolution of the first output image frame.

7. The image capture module of claim 1, wherein the image temporary storage module comprises an image compression unit disposed in front of the buffer memory unit, the output image stream is temporarily stored in the buffer memory unit after being processed by the image compression unit.

8. The image capture module of claim 1, wherein the buffer memory unit comprises a plurality of buffers, a plurality of output image frames of the output image stream is stored into the plurality of buffers in order, once an output image frame of the plurality of output image frames is stored into the last buffer of the plurality of buffers, the following output image frames are stored into the plurality of buffers starting in order from the first buffer of the plurality of buffers.

9. The image capture module of claim 1, wherein the first output image frame outputted from the buffer memory unit is transmitted to the preview interface module for outputting.

10. The image capture module of claim 1, wherein the image signal processor starts to output the output image stream to the image temporary storage module according to an image capture preparing command.

11. The image capture module of claim 10, further comprising a shutter and a central processing unit, wherein the central processing unit is respectively connected to the image signal processor and the image temporary storage module, the shutter has a first trigger and a second trigger, the first trigger generates the image capture preparing command and the second trigger generates the image capture command.

12. The image capture module of claim 1, wherein the first preview image frame is a last frame outputted by the preview interface module.

13. An image capture method for capturing images from an image data stream provided by an image source, the image capture method comprising steps of
generating a preview image stream according to the image data stream, wherein the preview image stream comprises a first preview image frame;
transmitting the preview image stream to a preview interface module to output the preview image stream;
generating an output image stream according to the image data stream, wherein the output image stream comprises a first output image frame corresponding to the first preview image frame;
transmitting the output image stream to an image temporary storage module to temporarily store the output image stream in a buffer memory unit of the image temporary storage module; and
receiving an image capture command and outputting the first output image frame from the buffer memory unit according to the image capture command, wherein the image capture command is generated after the preview interface module receives and outputs the first preview image frame.

14. The image capture method of claim 13, wherein the preview image stream comprises a second preview image frame following the first preview image frame, a time point of the central processing unit receiving the image capture command occurring during the receiving and outputting of the second preview image frame by the preview interface module; wherein the step of outputting the first output image frame comprises a step of determining the outputting of the first output image frame according to the time point and a default preview delay time.

15. The image capture method of claim 13, wherein the step of outputting the first output image frame outputting comprises a step of determining the outputting of the first output image frame from the buffer memory unit according to an identification number of the first preview image frame.

16. The image capture method of claim 13, wherein a timing of the preview interface module receiving and outputting the first preview image frame and a timing of the image temporary storage module receiving and temporarily storing the first output image frame are simultaneous.

17. The image capture method of claim 13, wherein the step of generating the preview image stream comprises a step of lowering a resolution of the image data stream to generate the preview image stream.

18. The image capture method of claim 13, wherein the step of transmitting the output image stream comprises steps of:
transmitting the output image stream to an image compression unit of the image temporary storage module to process the output image stream; and
storing the processed output image stream in the buffer memory unit temporarily.

19. The image capture method of claim 13, wherein the step of transmitting the output image stream comprises steps of:
storing a plurality of output image frames of the output image stream into a plurality of buffers in order; and
storing subsequent output image frames of the plurality of output image frames into the plurality of buffers in order starting from the first buffer of the plurality of buffers once an output image frame of the plurality of output image frames has been stored into the last buffer of the plurality of buffers.

20. The image capture method of claim 13, wherein the step of generating the output image stream comprises a step of starting to output the output image stream to the image temporary storage module according to an image capture preparing command.
